(19) United States
(12) Patent Application Publication
(10) Pub. No.: US 2011/0266884 A1
(43) Pub. Date: Nov. 3, 2011

(54) ELECTRIC POWER TRANSMISSION APPARATUS AND NONCONTACT ELECTRIC POWER TRANSMISSION SYSTEM

(75) Inventors: Naoki Wako, Miyagi (JP); Toshiaki Oka, Miyagi (JP)

(73) Assignee: NEC TOKIN CORPORATION

(21) Appl. No.: 13/143,901

(22) PCT Filed: Aug. 9, 2010
(86) PCT No.: PCT/JP2010/005002

§ 371 Date: Jul. 8, 2011

(30) Foreign Application Priority Data
Sep. 3, 2009 (JP) 2009-203421

(51) Int. Cl. H02M 3/28

(52) U.S. Cl. 307/104

(57) ABSTRACT

A system for transmitting electric power from an electric power transmission apparatus (10) to an electric power reception apparatus (50) by using electromagnetic induction between a power receiving coil (60) and a power transmitting coil (40). The electric power transmission apparatus (10) comprises an electric power switching circuit (14), a first capacitor (20) and an electric power derivation circuit (30). The electric power switching circuit (14) includes a switching element (16) and an output point (P) and switches the switching element (16) at a predetermined switching frequency (f), thereby causing the electrical potential at the output point (P) to exhibit a predetermined variation, wherein the predetermined variation is an electrical potential variation obtainable by the half-wave rectification of a sinusoidal wave variation which has a predetermined amplitude. The first capacitor (20) is coupled between the output point (P) and a first constant electrical potential (ground). The electric power derivation circuit (30) includes the power transmission coil (40) and is formed to cause an AC variation of the foregoing predetermined variation to occur between the both ends of the power transmission coil (40). The electric power derivation circuit (30) is coupled between the output point (P) and a second constant electrical potential (ground).

### TECHNICAL FIELD

This invention relates to a noncontact electric power transmission system which comprises an electric power reception apparatus having a power reception coil and an electric power transmission apparatus having a power transmission coil. Upon arrangement of the power reception coil of the electric power reception apparatus at a predetermined position in the vicinity of the power transmission coil, the noncontact electric power transmission system transmits electric power from the electric power transmission apparatus to the electric power reception apparatus by using electromagnetic induction between the power reception coil and the power transmission coil. For example, the electric power reception apparatus is a portable electronic device such as a cellular phone or a portable music player, while the electric power transmission apparatus is an electric recharging station or cradle for the portable electronic device.

### BACKGROUND ART

An electric power transmission apparatus drives a power transmission coil by using an electric power switching circuit having a switching element, so as to carry out electric power transmission from the power transmission coil to a power reception coil by using electromagnetic induction. In consideration of a recent application such as electric power transmission to portable electronic device and so on, it is required to increase switching frequency. On the other hand, some circuit structures of an electric power switching circuit cause problems such as higher calorific value or larger electric power loss when switching frequency is increased.

Under the above-described background, Patent Document 1 proposes an electric power transmission apparatus which includes an electric power switching circuit and has high switching frequency, wherein the electric power switching circuit can be effectively excited with low heat generation and low power loss. The electric power switching circuit of Patent Document 1 is based on a self-excited Colpitts oscillator circuit, wherein its power transmission coil is arranged in a feedback loop to the switching element of the electric power switching circuit.

### PRIOR ART DOCUMENTS

### Patent Document(s)

Patent Document 1: JPB2673876

### DISCLOSURE OF INVENTION

### Problems to be Solved by Invention

However, the arrangement of the power transmission coil in the feedback loop to the switching element impedes a large electric power transmission from the power transmission coil to the power reception coil.

It is therefore an object of the present invention to provide an electric power transmission apparatus that has effects of Patent Document 1 such as high switching frequency and, in addition, makes it possible to transmit large electric power in comparison with Patent Document 1.

### Means for Solving the Problems

An aspect of the present invention provides an electric power transmission apparatus including a power transmission coil, wherein the electric power transmission apparatus is configured to, upon arrangement of a power reception coil of an electric power reception apparatus at a predetermined position in the vicinity of the power transmission coil, transmit electric power to the electric power reception apparatus by using electromagnetic induction between the power reception coil and the power transmission coil. The electric power transmission apparatus comprises an electric power switching circuit, a first capacitor and an electric power derivation circuit. The electric power switching circuit includes a switching element and an output point. Switching of the switching element at a predetermined switching frequency causes predetermined variation of an electrical potential at the output point, wherein the predetermined variation is an electrical potential variation obtainable by carrying out half-wave rectification for a sinusoidal wave variation having a predetermined amplitude. The first capacitor is coupled between the output point and a first constant electrical potential. The electric power derivation circuit includes the power transmission coil. The electric power derivation circuit is coupled between the output point and a second constant electrical potential to cause, between opposite ends of the power transmission coil, an alternating current variation which is included in the predetermined variation.

### Advantageous Effect of Invention

In the electric power transmission apparatus according to one aspect of the present invention, the power transmission coil is arranged not in within the electric power switching circuit but out of the electric power switching circuit. Therefore, it is possible to transmit large electric power from the power transmission coil to the power reception coil.

In a noncontact electric power transmission system, the power transmission coil/the power reception coil is formed by disposing a planar coil on a substrate, wherein the substrate is made of magnetic material which has permeability of 1000 or less, and the number of turns of the planar coil is 1 to 10 turns. The formation decreases impedance of the power transmission coil/the power reception coil. Furthermore, a space is left between the wound wires of the power transmission coil/the power reception coil so that, even if positions of the power transmission coil and the power reception coil are not matched with each other, drastic degradation of electric power transmission efficiency can be reduced. Because of the above matters, it becomes possible to strengthen magnetic coupling between the power transmission coil and the power reception coil to heighten the electric power transmission efficiency therebetween.

### BRIEF DESCRIPTION OF DRAWINGS

FIG. 1 is a schematic block diagram which shows a noncontact electric power transmission system according to a first embodiment of the present invention.

FIG. 2 is a schematic graph which shows an electrical potential variation (predetermined variation) at a “P” point in the noncontact electric power transmission system of FIG. 1.

FIG. 3 is a schematic block diagram which shows a noncontact electric power transmission system according to a second embodiment of the present invention.

FIG. 4 is a schematic plan view which shows an example of a power transmission coil/a power reception coil used in the noncontact electric power transmission system of FIG. 3.

FIG. 5 is a schematic plan view which shows a comparative example of the power transmission coil/the power reception coil of FIG. 4.

FIG. 6 is a view which shows variation of output electric power upon positional mismatching of the power transmission coil with the power reception coil.

### BEST MODE FOR CARRYING OUT INVENTION

### First Embodiment

With reference to FIG. 1, a noncontact electric power transmission system according to a first embodiment of the present invention comprises an electric power transmission apparatus 10 having a power transmission coil 40 and an electric power reception apparatus 50 having a power reception coil 60. Namely, the power transmission coil 40 and the power reception coil 60 are separable from each other.

The noncontact electric power transmission system according to the present embodiment is configured to, upon arrangement of the power reception coil 60 of the electric power reception apparatus 50 at a predetermined position in the vicinity of the power transmission coil 40, transmit electric power from the electric power transmission apparatus to the electric power reception apparatus by using electromagnetic induction between the power reception coil 60 and the power transmission coil 40. The electric power reception apparatus 50 is for example a portable electronic device. The electric power transmission apparatus 10 is for example an electric recharging station or cradle for the portable electronic device.

The electric power transmission apparatus 10 comprises an oscillator circuit 12, an electric power switching circuit 14, a first capacitor 20 and an electric power derivation circuit 30. The oscillator circuit 12 generates an oscillation signal which has a predetermined switching frequency f.

The electric power switching circuit 14 comprises a switching element 16 coupled between an output point P and a ground (third constant electrical potential) and an electric power variation inductor 18 coupled between the output point P and a power supply VDD (fourth constant electrical potential). The switching element 16 according to the present embodiment is an nMOSFET, wherein its drain terminal is connected to the output point P, while its source terminal is connected to the ground. To the switching element 16, especially a gate of the nMOSFET, the oscillator circuit 12 is connected. A predetermined switching frequency f is input from the oscillator circuit 12 to the switching element 16 so that the switching element 16 carries out switching operation at the predetermined switching frequency f. Thus, the electric power switching circuit 14 causes predetermined variation of an electrical potential V_{P} at the output point P.

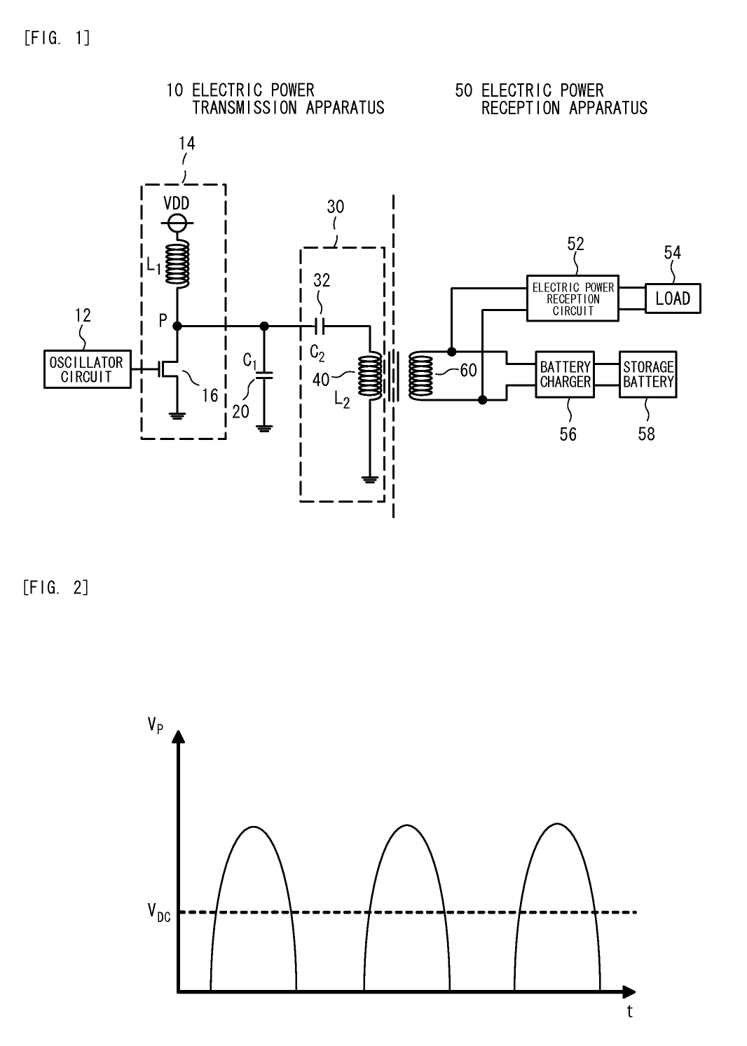

The predetermined variation is an electrical potential variation obtainable by carrying out half-wave rectification for a sinusoidal wave variation having a predetermined amplitude, as shown in FIG. 2. In other words, the predetermined variation is an electrical potential variation obtainable by taking out only positive parts of the sinusoidal wave variation. The predetermined variation is set up by adjusting the predetermined switching frequency f and a value of inductance L₁ of the electric power variation inductor 18. Note here that an electrical potential indicated by V_{DC} in FIG. 2 is a time-averaged electrical potential of the electrical potential V_{P} at the output point P. Namely, the electrical potential V_{DC} is a DC component of the predetermined variation of the electrical potential V.

The first capacitor 20 is coupled between the output point P and a ground (first constant electrical potential) and has capacitance C₁. In the present embodiment, the capacitance C1 is determined in consideration of the electric power derivation circuit 30, as described later.

The electric power derivation circuit 30 is coupled between the output point P and the ground (second constant electrical potential). Specifically, the electric power derivation circuit 30 according to the present embodiment comprises a second capacitor 32 coupled to the output point P and the power transmission coil 40 coupled between the second capacitor 32 and the ground (second constant electrical potential). Namely, the electric power derivation circuit 30 is formed by connecting the second capacitor 32 and the power transmission coil 40 in series. The electric power derivation circuit 30 is a circuit for deriving an alternating-current (AC) component (V_{AC}=V_{P}−V_{DC}) of the variation of the electrical potential V_{P} at output point P, i.e., the predetermined variation, by the use of the power transmission coil 40. Namely, the electric power derivation circuit 30 is for causing the AC variation of the predetermined variation to occur between the both ends of the power transmission coil 40. The second capacitor 32 is for removing the DC component from the predetermined variation and has capacitance C₂. The power transmission coil 40 has inductance L₂ as seen from the output point P under arrangement of the power reception coil 60 at the predetermined position. In other words, the inductance L2 does not consist of inductance of the power transmission coil 40 alone but is inductance of the power transmission coil 40 which includes a mutual inductance due to the arrangement of the power reception coil at the predetermined position.

A first resonant frequency f₁ is expressed by the following mathematical expression (1), wherein the first resonant frequency f₁ is a resonant frequency in a case where a serial resonant circuit is formed by the first capacitor 20 and the second capacitor 32 and the power transmission coil 40, and the first resonant frequency f₁ is calculated under a condition where the power transmission coil 40 has the inductance L₂.

$$\begin{matrix}[ Mathematical Expression 1 ] & \\ {( 2 π {f}_{1} )}^{2} \cdot {L}_{2} \cdot \frac{{C}_{1} \cdot {C}_{2}}{{C}_{1} + {C}_{2}} = 1 & ( 1 )\end{matrix}$$

Similarly, a second resonant frequency f₂ is expressed by the following mathematical expression (2), wherein the second resonant frequency f₂ is a resonant frequency in a case where a serial resonant circuit is formed by the second capacitor 32 and the power transmission coil 40, and the second resonant frequency f₂ is calculated under a condition where the power transmission coil 40 has the inductance L₂.

[Mathematical Expression 2]

(2πf₂)²×L₂·C₂=1 (2)

If the switching element 16 is turned off, it is assumed that the serial resonant circuit, which is formed by the first capacitor 20 and the second capacitor 32 and the power transmission coil 40, functions at the first resonant frequency f₁. On the other hand, if the switching element 16 is turned on, it is assumed that the serial resonant circuit, which is formed by the second capacitor 32 and the power transmission coil 40, functions at the second resonant frequency f₂. Therefore, in order to take the output of the electric power switching circuit 14 with high efficiency, it is preferable that the first resonant frequency f₁ is higher than the predetermined switching frequency f, while the second resonant frequency f₂ is lower than the predetermined frequency f. Namely, the first resonant frequency f₁, the second resonant frequency f₂ and the predetermined frequency f meet the following mathematical expression (3), preferably.

[Mathematical Expression 3]

f₂<f<f₁ (3)

Furthermore, in view of ensuring performance reliability, it is preferable that the first resonant frequency f1 meets the following mathematical expression (4), and it is also preferable that the second resonant frequency f2 meets the following mathematical expression (5).

[Mathematical Expression 4]

f<f₁<2f (4)

[Mathematical Expression 5]

0.5f<f₂<f (5)

Although the switching element 16 is an nMOSFET in the above-described embodiment, other elements may be used. Although each of the first constant electrical potential, the second constant electrical potential and the third constant electrical potential is the ground, they may be electrical potentials other than the ground, provided that they are constant electrical potentials.

The electric power reception apparatus 50 comprises an electric power reception circuit 52 coupled to the power reception coil 60, a load 54 coupled to the power reception circuit 52, a battery charger 56 coupled to the power reception coil 60, and a storage battery 58 coupled to the battery charger 56. As described above, the electric power transmitted from the power transmission coil 40 of the electric power transmission apparatus 10 to the power reception coil 60 of the electric power transmission apparatus 50 is stored in the storage battery 58 through the battery charger 56, while supplied for the load 54 through the electric power reception circuit 52. While the power reception coil 60 does not receive electric power (i.e., the power reception coil 60 is not arranged at the predetermined position), the storage battery 58 discharges electricity to supply electric power for the load 54 through the battery charger 56 and the electric power reception circuit 52.

As described above, since the power transmission coil 40 is arranged outside of the electric power switching circuit 14, restrictions on magnitude of transmittable electric power are removed. Since the relation between the switching frequency and every elements is adjusted to meet the aforementioned mathematical expressions (1)˜(3), heightening of the switching frequency to 1 MHz or more and high efficiency of electric power transmission (low loss of electric power) can be achieved, while generated heat can be suppressed low. In short, the present embodiment can realize downsizing and profile-lowering of the electric power transmission apparatus 10 without problems on its characteristics. In addition, a circuit structure of the electric power transmission apparatus 10 according to the present embodiment is very simple, as apparent from FIG. 1.

### Second Embodiment

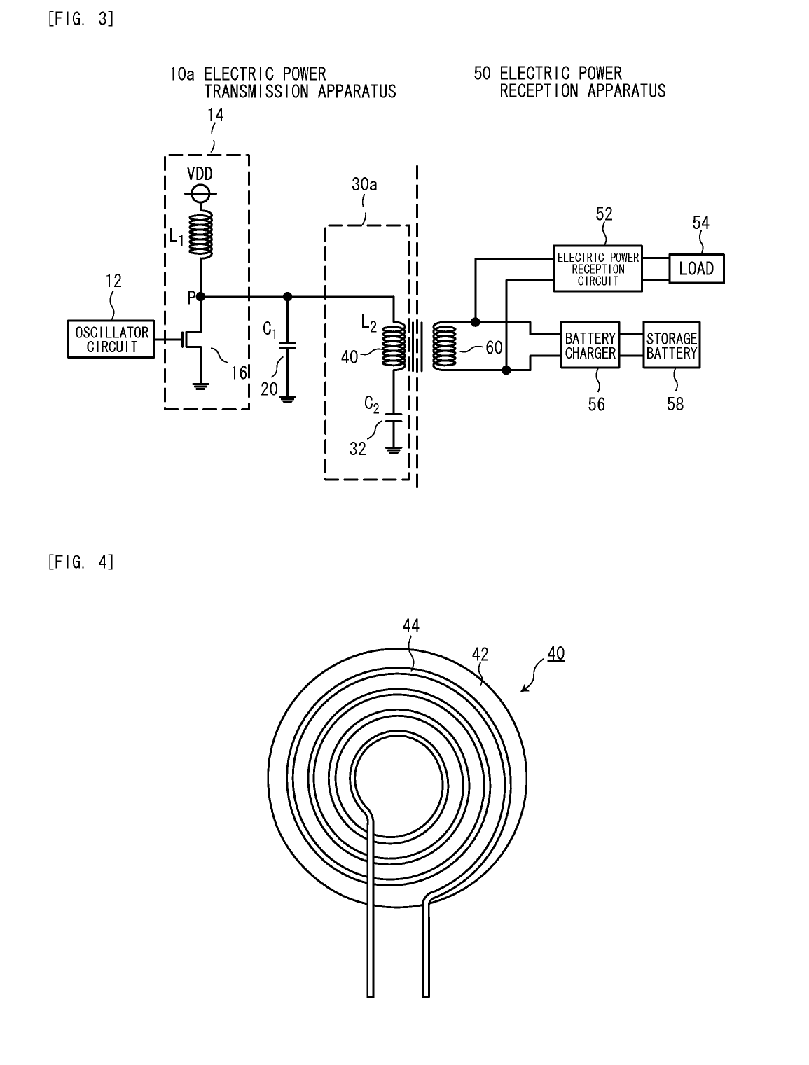

With reference to FIG. 3, a noncontact electric power transmission system according to a second embodiment of the present invention is a modification of the above-described noncontact electric power transmission system according to the first embodiment and has the same structure as that of the noncontact electric power transmission system according to the first embodiment, except for a different structure of an electric power derivation circuit 30a of an electric power transmission apparatus 10a. Therefore, the following explanation is directed to the different structure of the electric power derivation circuit 30a, while omitting explanations about other components.

The electric power derivation circuit 30a according to the present embodiment comprises the power transmission coil 40 coupled to the output point P and the second capacitor 32 coupled between the power transmission coil 40 and the ground (second constant electrical potential). In other words, the electric power derivation circuit 30a is also formed by connecting the second capacitor 32 and the power transmission coil 40 in series and is a circuit for deriving an alternating-current (AC) component (V_{AC}=V_{P}−V_{DC}) of the variation of the electrical potential V_{P} at output point P, i.e., the predetermined variation, by the use of the power transmission coil 40.

The noncontact electric power transmission system according to the present embodiment is also formed to meet the above-described mathematical expressions (1)˜(5). As understood from that, either the second capacitor 32 or the power transmission coil 40 may be coupled to the output point P, provided that the mathematical expressions (1)˜(3) are met. The second capacitor 32 may be divided into two capacitors, between which the power transmission coil 40 is put so that the two capacitors and the power transmission coil 40 are connected in series to form the electric power derivation circuit 30a. Any modifications can get similar effects to the above-described first embodiment, provided that the aforementioned mathematical expressions (1)˜(3), preferably, the mathematical expressions (1)˜(5).

Concrete examples of values of inductance and capacitance of every elements in the present embodiments are described here. For the inductance L₂ of the power transmission coil 40 as seen from the output point P under the arrangement of the power reception coil 60 at the predetermined position, L₂=2.64 μH. For the inductance L₁ of the electric power variation inductor 18, L₁=14.57 μH. For the capacitance C₁ of the first capacitor 20, C₁=75.67 pF. For the capacitance C₂ of the second capacitor 32, C₂=61.04 pF. The predetermined switching frequency f is 13.56 MHz. These values are substituted for the mathematical expression (1) to calculate it, the following result is obtained.

f=0.6474*f₁ (6)

Similarly, those values are substituted for the mathematical expression (2) to calculate it, the following result is obtained.

f=1.170*f₂ (7)

Namely, if inductances, capacitances and the predetermined switching frequency are set as the aforementioned values, their result is f₂<f<f₁, which meets the mathematical expression (3).

The electric power transmission apparatus 10 was actually formed to meet the conditions of inductances, capacitances and the predetermined switching frequency, and electric power was transmitted between the electric power transmission apparatus 10 and the electric power reception apparatus 50. Upon the transmission, input impedance of the power transmission coil 40 was measured. When a real component (R) of the impedance was 28.5Ω, an amount of transmitted electric power was 2.9 W. If an amount of transmitted electric power and properties of the power transmission coil 40 and/or the power reception coil 60 are changed, set values of L₁, L₂, C₁, and C₂ are required to be changed. in even such case, if values of every elements and the switching frequency are set to meet the conduction of the mathematical expression (3), i.e., f₂<f<f₁, high efficiency of electric power transmission can be obtained.

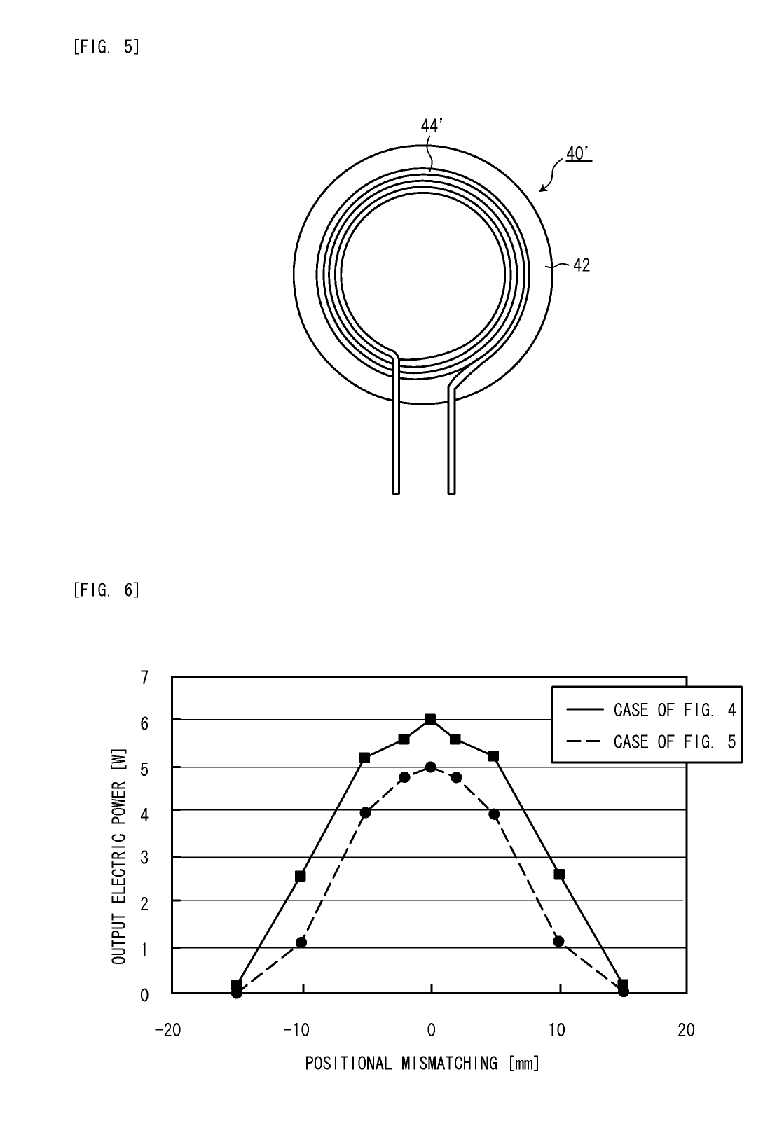

FIG. 4 is a plan view which shows an example of a structure of the power transmission coil 40 used in the noncontact electric power transmission system of the present embodiments. The power reception coil 60 is designed to have similar structure to the power transmission coil 40. The power transmission coil 40 is formed by winding wires with a spacing left between the wound wires. In detail, the power transmission coil 40 is formed by disposing a planar coil 44 of four turns on a magnetic substrate which has permeability of 10 or less; the power transmission coil 40 has a small impedance.

The planar coil 44 may be formed on a printed circuit board by the use of its conductive pattern. In that case, it is formed on a molded circuit board through a process of patterning, plating, etching and etc. for the coil pattern. The planar coil 44 may be formed by using a single wire such as a polyurethane-coated copper wire, a polyester-coated copper wire, an enamel-coated copper, or a strand of two or more of the above-mentioned single wires, or a bundle of the above-mentioned single wires. The planar coil 44 may be formed by using a fusion copper which is formed by baking a fusion coat, such as a thermoplastic resin or a thermosetting resin, on the above-mentioned single wire. The planar coil 44 may be formed by using a multi-parallel wire which is formed by arranging two or more of the above-mentioned single wires in parallel, followed by bonding them. The shape of the planar coil 44 may be designed to be suitable for a shape of a housing in which it is mounted.

The magnetic substrate 42 may be formed by using nickel-based ferrite which has a thickness of 1 mm or less and has a permeability of 1000 or less. The shape of the magnetic substrate 42 may be designed to be suitable for a shape of a housing in which it is mounted.

The magnetic substrate 42 may be formed by using magnetic material other than the aforementioned nickel-based ferrite, such as manganese-based ferrite, amorphous magnetic alloy, permalloy of Fe—Ni based alloy, nanocrystalline magnetic material. The magnetic material may have a sheet-like shape. It may be a magnetic coating. Magnetic filler or magnetic powder made of the aforementioned material may be mixed into resin.

The above-described power transmission coil 40 and a coil 40′ of a comparative example shown in FIG. 5 were formed and evaluated. The coil 40′ was formed by winding wires without a spacing left between the wound wires and, in other points, was same as the power transmission coil 40 shown in FIG. 4.

Specifically, as an example of the power transmission coil 40 (power reception coil 60) of FIG. 4, the planar coil 44 was formed and had an outer diameter φ of 29 mm, a wire diameter of 0.5 mm, four turns, and a spacing of 2 mm left between the wound wires, while the magnetic substrate 42 was formed by using nickel-based ferrite and had a disc shape which had an outer diameter φ of 30 mm and a thickness of 0.2 mm. The magnetic substrate 42 had permeability of 800. With the thus formed coil, electric power of 6 watts could be supplied through electric power transmission at the predetermined switching frequency f=13.56 MHz.

On the other hand, as an example of the power transmission coil 40′ (power reception coil 60) of FIG. 5, the planar coil 44′ was formed and had an outer diameter φ of 25 mm, a wire diameter of 0.5 mm, four turns, and no spacing left between the wound wires, while the magnetic substrate 42 was formed by using nickel-based ferrite and had a disc shape which had an outer diameter φ of 30 mm and a thickness of 0.2 mm. The magnetic substrate 42 had permeability of 800. With the thus formed coil, electric power of 4.5 watts could be supplied through electric power transmission at the predetermined switching frequency f=13.56 MHz.

Changes of efficiency due to positional mismatching of the power transmission coil and the power reception coil were evaluated. Specifically, a coil having the structure shown in FIG. 5 was used as the power reception coil. On the other hand, as the power transmission coil, a coil having the structure of FIG. 4 (the structure with a spacing left between the wound wires) and another coil having the structure of FIG. 5 (the structure without a spacing left between the wound wires) were formed. Changes of output electric power were evaluated about cases of positional mismatching of the power reception coil with the respective power transmission coil. Evaluation results are shown in FIG. 6. As apparent from FIG. 6, in case of the use of the planar coil 44 with a spacing left between the wound wires, changes of the output electric power are small even on the positional mismatching; if the positional mismatching falls within a range of ±5 mm, an output of 5 V or more can be obtained.

Suitable values of the number of turns and impedances of the planar coils for the power transmission coil and the power reception coil are different depending on the use of the noncontact electric power transmission system, the degree of the requirement on its downsizing, desired supply of electric power and etc. However, if the number of turns is 1 to 10 turns, it is applicable to various wide applications. If the spacing between the wound wires of the coil is 0.1 mm or more, redundancy for the positional mismatching between the power transmission coil and the power reception coil can be improved in comparison with a case of the structure with almost zero spacing as the prior art.

Needless to say, the present invention is not limited to the above-mentioned embodiments. Modifications on material or structure may be made thereto without departing from the spirit of the invention. For example, it is generally expected that the load 9 of the electric power reception circuit 50 is a resistor as its equivalent circuit. However, a load including a capacitance component in series or in parallel or another load including an inductance component may be used; even in that case, the effect of the present effects can be obtained. To the electric power transmission apparatus 10, electric parts or a circuit other than the illustrated elements may be added. A semiconductor switching element other than FET may be used as a voltage-driven switching element.

### DESCRIPTION OF NUMERALS

10, 10a Electric Power Transmission Apparatus
12 Oscillator Circuit
14 Electric Power Switching Circuit
16 Switching Element
18 Electric Power Variation Inductor
20 First Capacitor
30, 30a Electric Power Derivation Circuit
40 Power Transmission Coil
42 Magnetic Substrate
44 Planar Coil
50 Electric Power Reception Apparatus
52 Electric Power Reception Circuit
54 Load
56 Battery Charger
58 Storage Battery
60 Power Reception Coil

1. An electric power transmission apparatus including a power transmission coil, the electric power transmission apparatus being configured to, upon arrangement of a power reception coil of an electric power reception apparatus at a predetermined position in the vicinity of the power transmission coil, transmit electric power to the electric power reception apparatus by using electromagnetic induction between the power reception coil and the power transmission coil, the electric power transmission apparatus comprising:
an electric power switching circuit including a switching element and an output point, switching of the switching element at a predetermined switching frequency causing predetermined variation of an electrical potential at the output point, the predetermined variation being an electrical potential variation obtainable by carrying out half-wave rectification for a sinusoidal wave variation having a predetermined amplitude;
a first capacitor coupled between the output point and a first constant electrical potential; and
an electric power derivation circuit including the power transmission coil, the electric power derivation circuit being coupled between the output point and a second constant electrical potential to cause, between opposite ends of the power transmission coil, an alternating current variation which is included in the predetermined variation.

2. The electric power transmission apparatus as recited in claim 1, wherein:
the switching element is coupled between a third constant electrical potential and the output point;
the electric power switching circuit further comprises an electrical potential variation inductor coupled between a fourth constant electrical potential and the output point; and
the predetermined variation is determined by the predetermined switching frequency f and inductance of the electrical potential variation inductor.

3. The electric power transmission apparatus as recited in claim 2, wherein the third constant electrical potential is a ground.

4. The electric power transmission apparatus as recited in claim 2, wherein:
the electric power derivation circuit comprises the power transmission coil and a second capacitor directly coupled to the power transmission coil; and
a second resonant frequency f₂ is lower than the predetermined switching frequency f, wherein the second resonant frequency f₂ is a resonant frequency in a case where a serial resonant circuit is formed by the power transmission coil and the second capacitor, and the second resonant frequency f₂ is calculated by using inductance of the power transmission coil in a case where the power transmission coil is viewed from the output point when the power reception coil is arranged at the predetermined area.

5. The electric power transmission apparatus as recited in claim 4, wherein the second resonant frequency f₂ meets the following condition for the predetermined switching frequency f: 0.5f<f₂<f.

6. The electric power transmission apparatus as recited in claim 4, wherein a first resonant frequency f₁ is higher than the predetermined switching frequency f, the first resonant frequency f₁ is a resonant frequency in a case where a serial resonant circuit is formed by the power transmission coil and the first capacitor and the second capacitor, and the first resonant frequency f₁ is calculated by using inductance of the power transmission coil in a case where the power transmission coil is viewed from the output point when the power reception coil is arranged at the predetermined area.

7. The electric power transmission apparatus as recited in claim 6, wherein the first resonant frequency f₁ meets the following condition for the predetermined switching frequency f: f<f₁<2f.

8. The electric power transmission apparatus as recited in claim 2, wherein the predetermined switching frequency is designed to be 1 MHz or more.

9. The electric power transmission apparatus as recited in claim 1, wherein each of the first constant electrical potential and the second constant electrical potential is a ground.

10. A noncontact electric power transmission system comprising:
the electric power transmission apparatus as recited in claim 1; and
the electric power reception apparatus including the power reception coil.

11. The noncontact electric power transmission system as recited in claim 10, wherein:
each of the power transmission coil and the power reception coil is formed by disposing a planar coil on a substrate;
the substrate is made of magnetic material which has permeability of 1000 or less; and
the number of turns of the planar coil is 1 to 10 turns.

12. The noncontact electric power transmission system as recited in claim 11, wherein the planar coil is formed by winding wires with a spacing of 0.1 mm or more left between the wound wires.
